(19) United States
(12) Patent Application Publication
(10) Pub. No.: US 2007/0036161 A1
(43) Pub. Date: Feb. 15, 2007

(54) System and method of routing Ethernet MAC frames using Layer-2 MAC addresses

(76) Inventor: Atul B. Mahamuni, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/486,479

(22) Filed: Jul. 13, 2006

Related U.S. Application Data
(60) Provisional application No. 60/699,066, filed on Jul. 13, 2005.

(51) Int. Cl. H04L 12/56

(52) U.S. Cl. 370/392

(57) ABSTRACT

A method and apparatus is disclosed herein for routing information in a communication network. In one embodiment, the method comprises receiving frames, and routing the frames in a network using Layer-2.

### PRIORITY

The present patent application claims priority to and incorporates by reference the corresponding provisional patent application Ser. No. 60/699,066, titled “System and Method of Routing Ethernet Mac Frames Using Layer-2 Mac Addresses”, filed on Jul. 13, 2005.

### BACKGROUND OF THE INVENTION

The present invention is related to the field of network communications; more specifically, the present invention is related to routing information using Layer-2 (L2).

### FIELD OF THE INVENTION

ISO-OSI Stack and TCP/IP:

The Open System Interconnect (OSI) stack defines layered network architecture. The OSI model divides the networking functions in 7 layers. Each layer provides services for the layer above it, by utilizing the services provided by the layers below it. FIG. 1 illustrates the seven-layer model, and mapping of seven-layer model to TCP/IP protocol suite.

Two important layers in consideration here are the data link layer and the network layer.

Layer-2 (Data Link Layer):

The data link layer provides functional and procedural means to transfer data between various network elements, and to detect and possibly correct errors that occur in the Physical layer. The addressing scheme used in Layer-2 is a flat addressing scheme (e.g. MAC address in Ethernet networks), and it is often hard-coded in the Network interface cards.

Typically, bridges and switches operate at Layer-2, and they provide connectivity between directly attached, or locally attached network elements.

Layer-3 (Network Layer):

The network layer provides functional and procedural means to transfer variable length data sequences from a source to a destination (or multiple destinations) via one or more networks. The network layer performs the function of “routing” data based on the destination Layer-3 address (For example, an IP-address). The routing process involves selection of a path from a set of alternatives, based on the destination Layer-3 address.

Spanning Tree Protocol (STP):

Layer-2 networks are often built with redundant links. These redundant links provide multiple paths connecting multiple Layer-2 devices (e.g., bridges and switches) for the purpose of adding resiliency in the network. However, introduction of multiple paths creates problems in the network since it often creates loops in the network, causing incorrect learning in the bridges and switches, and frame-looping in the network. To avoid these problems, a Spanning Tree Protocol is used, which configures the bridges and switches such that a loop-free topology is determined. In order to enforce loop-free topology, the Spanning Tree Protocol configures certain ports into blocking state, and the network links connected to these ports are not utilized for application data communication. The philosophy of Spanning Tree Protocols is commonly summarized as: Redundant paths are good, active redundant paths are bad (they cause loops).

VLANs

Virtual Local Area Networks (VLANs) allow network administrators to logically separate the network by function, by application, or by department. VLANs behave very similar to the physical LAN network, and network administrator can group end-stations or servers in the same VLAN even if they are not connected to the same physical LAN. VLANs are defined by IEEE 802.1Q standard. VLANs are often configured to reduce the size of the MAC-level broadcast domain in a large Layer-2 network in order to improve performance. Another purpose of VLANs is to restrict access to network resources to a certain set of network elements.

### DESCRIPTION OF THE RELATED ART

| Patent # | Date | Inventor | Title |
|---|---|---|---|
| U.S. Pat. No. | Jan 13, | Cansever | Method and apparatus for |
| 6678252 | 2004 | | dynamic source routing |
| | | | in ad hoc wireless networks |

MAC based Source Routing is described in this prior art, which teaches Source in “wireless” networks, and uses “bandwidth” as a parameter.

The prior art fails to teach or suggest Ethernet MAC based routing; it teaches outing (method performed by the first node.

| Patent # | Date | Inventor | Title |
|---|---|---|---|
| 6,907,469 | Jun. 14, | Gallo, et | Method for bridging and |
| | 2005 | al. | routing data frames via |
| | | | a network switch |
| | | | comprising a special |
| | | | guided tree handler |
| | | | processor |

This prior art teaches method for bridging and routing data frames via a network switch. Logical bridging and routing functions required for this process entails address lookups in routing tables and address databases.

This prior art fails to teach Ethernet MAC based routing. It teaches a separate dress database (with a Guided Tree Handler) and a separate logical router with (Layer-3) L3 table.

| Patent # | Date | Inventor | Title |
|---|---|---|---|
| 6,907,040 | Jun. 14, | Matsuzawa | Router apparatus and |
| | 2005 | | frame transfer method |

This prior art teaches a method for reducing the heavy load presented to a conventional router in terms of conversion from datalink layer frame into network layer packet, search through the network layer routing table, and re-conversion from a packet into a datalink frame. It teaches a method of determining next hop node in datalink layer without referring to network layer information. This is performed using a separate signaling message containing the information indicating that datalink layer switching is to be performed.

In addition, Shortest Path First algorithms have been widely used for the purpose of routing in Layer-3 networks for many years. Popular routing protocols such as OSPF (IETF RFC 2328 authored by J. Moy, April 1998) uses Shortest Path First algorithm applied to TCP/IP networks, with routing implemented at IP (Network) layer.

### SUMMARY OF THE INVENTION

A method and apparatus is disclosed herein for routing information in a cation network. In one embodiment, the method comprises receiving frames, and the frames in a network using Layer-2.

### DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 shows background information on the OSI stack and mapping of TCP/IP protocols onto OSI stack.

FIG. 2 shows an exemplary network in which the Ethernet Frame Routing technology can be deployed.

FIG. 3 is an operational flow diagram illustrating a process of ESPF Ethernet MAC level Route Protocol.

FIG. 4 is an operational flow diagram illustrating a process of EFR forwarding.

### DETAILED DESCRIPTION OF THE PRESENT INVENTION

The present invention is directed to “routing” at datalink layer, and not “switching” at datalink layer. In one embodiment, the present invention is directed to routing at “Ethernet MAC (Layer-2)”. To that end, “route-lookups” are based on MAC addresses.

The present invention may be applied to hop-by-hop routing (a method performed by first and intermediate nodes).

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-medium readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals etc.); etc.

Overview

As stated above, the Spanning Tree Protocol (STP) in the network disables active parallel paths at Layer-2. This results in the underutilization of network resources. This could also result in creation of hotspots in the network. The Bridge or Switch elected as the Root-Bridge could become the bottleneck in the system. In addition, the path traversed by the Layer-2 packets could be non-optimal for the given configuration of the network. This invention allows enabling multiple active redundant paths in the Layer-2 network.

Existing Ethernet switches and routers perform Layer-3 actions such as “Destination IP Address” lookup in the Layer-3 routing database to decide the next-hop router's IP address, and/or Layer-2 actions such as MAC-based lookup in the learnt forwarding database to decide the forwarding port. Because an embodiment of this invention defines a Layer-2 network in which multiple active redundant paths are feasible, an embodiment of this invention defines a method of performing “route” lookups to decide which Layer-2 path the packets need to follow. These multiple active redundant paths provide several benefits such as higher throughput, fast failover, hot-spot reduction, etc.

Briefly stated, embodiments of this invention are directed to a system and method for discovering, identifying, communicating information about a plurality of Layer-2 paths in the network, and then directing the Layer-2 traffic on these network paths simultaneously based on a MAC-level routing technique named “Ethernet Frame Routing (EFR)” as described herein. The Layer-2 switch is configured to perform the following actions:
1. Discovering a plurality of paths to the end-system identified by a Layer-2 MAC Address.
2. Monitoring the paths in the network for various relevant metrics (For example: utilization, bandwidth, latency, etc).
3. Maintaining a plurality of parallel active paths in the network by configuring special point-to-point VLANs called EFR-Transport VLANs.
4. Forwarding Layer-2 Ethernet frames by performing a Layer-2-Route-lookup using the MAC address (and not IP address) of the destination, and encapsulating the packets using the EFR-Transport VLANs.

In one aspect, this invention is directed to a method of discovering various parallel paths in the network for routing and forwarding Ethernet MAC frames. The method first establishes adjacencies between the neighboring Ethernet switches. The adjacencies are established and maintained using exchanges of Ethernet Shortest Path First (ESPF) Hello Protocol Data Units (Hello PDUs). The ESPF neighbors exchange the Link Layer State Advertisement (LLSA) messages carrying information about the states of their Ethernet links and reachability information about the destination MAC addresses. These LLSA messages are flooded in the Layer-2 network by participating ESPF switches. A modified Shortest Path First algorithm is run on every EFR switch to make a determination of multiple shortest paths to the destination MAC address in a prioritized order. Using these lists, an Ethernet Frame Forwarding Database (EFFD) is created for routing the datalink layer frames.

In another aspect, an embodiment of the invention is directed to a method of monitoring the network for various metrics such as utilization, bandwidth, latency etc, as observed by the Layer-2 MAC network. The method collects and presents these metrics as inputs to the SPF method described above.

In yet another aspect, an embodiment of the invention creates and maintains multiple parallel active paths in the network by defining and configuring special point-to-point VLANs called EFR-Transport VLANs. These VLANs are defined and configured solely for the use of inter-EFR switch traffic, and are separate from the rest of the VLANs defined in the existing network.

In still another aspect, an embodiment of the invention directed to a method of forwarding the Layer-2 Ethernet MAC frames by performing a route-lookup based on the destination MAC address (and not the destination IP address), and encapsulating the packet using the EFR-Transport VLANs defined and configured for the inter-EFR switch traffic.

In the following detailed description of exemplary embodiments of the invention, reference is made to the accompanied drawings, which form a part hereof, and which are shown by way of illustration, specific exemplary embodiments of which the invention may be practiced. These embodiments are described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined by the appended claims.

Definitions

The definitions in this section apply herein, unless the context clearly indicates otherwise.

“Including” and its variants mean including but not limited to. Thus, a list including A is not precluded from including B.

A “Layer-2 network” means a network of Layer-2 devices that interconnects a plurality of computing devices using Layer-2 network elements such as Ethernet bridges or Ethernet switches, and the one that is capable of performing Layer-2 bridging/switching services and MAC-based forwarding functions.

A “frame” includes to an arbitrary or selectable amount of data that may be represented by a sequence of one or more bits. A frame may correspond to a data unit found in Layer-2 of the Open Systems Interconnect (OSI) model.

The term “Ethernet Frame Routing” refers to a scheme of implementing Routing function at Layer-2 (Ethernet-MAC/LLC) level. The term EFR means “Ethernet Frame Routing”. The term “EFR switch” refers to a switch configured to perform “Ethernet Frame Routing”.

The term “Ethernet Shortest Path First” refers to a method of selecting a shorter or shortest path based on destination Layer-2 (Ethernet-MAC/LLC) addresses. The term ESPF means “Ethernet Shortest Path First”.

The term “Link Layer State Advertisement” refers to the advertisement control packet sent by the EFR switches or bridges to communicate control information to each other. This control information includes information about the states of the links, reachability information of Layer-2 (Ethernet-MAC/LLC) addresses, time stamps, optional security information, and sequence numbers. The term LLSA means “Link Layer State Advertisements”.

The term “Modified Shortest Path First algorithm” means an algorithm that makes determination about a plurality of short paths through the Layer-2 network in the prioritized order. The term MSPF refers to “Modified Shortest Path First Algorithm”.

The term “Ethernet Frame Forwarding Database” refers to a Layer-2 forwarding database that is configured such that the data-path traffic can perform lookups based on Destination Layer-2 (Ethernet-MAC) address. The term EFFD means “Ethernet Frame Forwarding Database”.

Referring to the drawings, like numbers indicate like parts throughout the figures document.

The meaning of “a,” “an,” and “the” include plural references. The meaning of “in” includes “in” and “on.”

Additionally, a reference to the singular includes a reference to the plural unless otherwise stated or is inconsistent with the disclosure herein.

Definitions of terms are also found throughout this document. These definitions be introduced by using “means” or “refers” to language and may be introduced by and/or function performed. Such definitions will also apply to this document, unless the clearly indicates otherwise.

Illustrative Environment

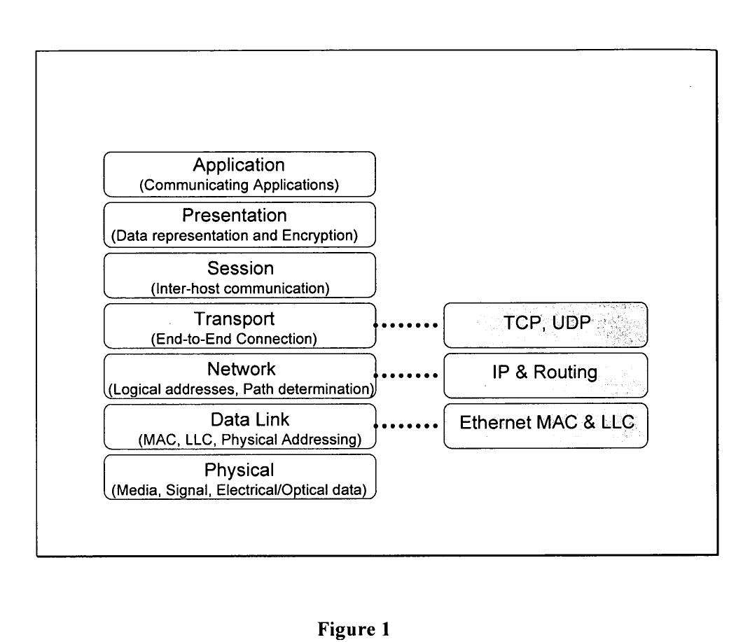

FIG. 1 shows the ISO OSI networking stack and it's mapping to the TCP/IP protocol suite. It may be noted that the Routing function is traditionally performed at Layer-3 or the Network Layer such as the Internet Protocol (IP) layer.

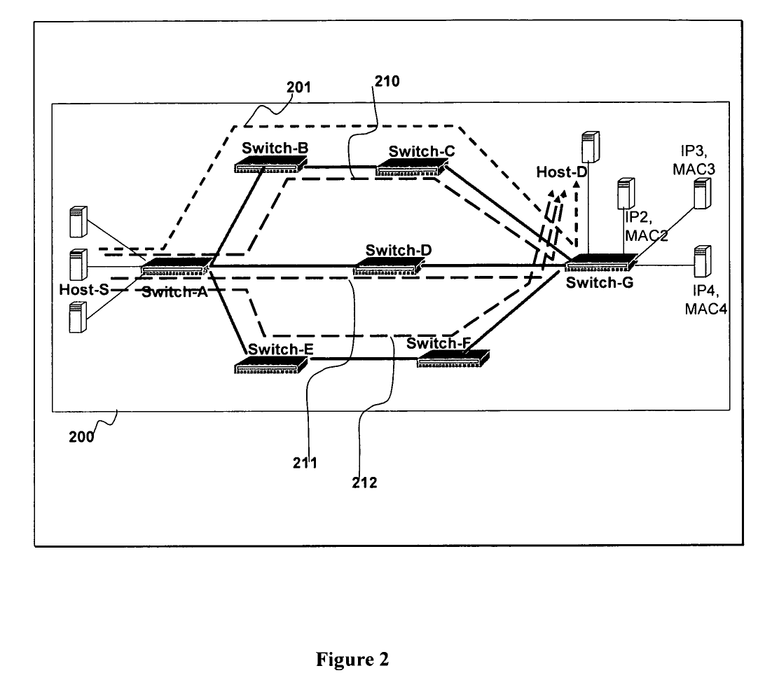

FIG. 2 shows an exemplary Layer-2 network. Such a Layer-2 network may be contain a plurality of servers, workstations, network appliances, bridges, switches, firewalls, network security devices, routers, gateways, etc. It will be appreciated that the Layer-2 network 200 may include many more components than those shown in FIG. 2. However, the components shown are sufficient to disclose an illustrative environment for practicing the present invention.

As shown in FIG. 2, the Spanning Tree Protocol will provide a single loop-free path 201 from Source (Host-S) to Destination (Host-D). It blocks the other active paths in the network for layer-2 traffic.

An embodiment of the invention enables discovery, maintenance and usage of a plurality of paths 210, 211, 212 from Source (Host-S) to Destination (Host-D). Using this invention, the data traffic from Source (Host-S) to Destination (Host-D) can follow any or multiple of the paths indicated by 210, 211, 212.

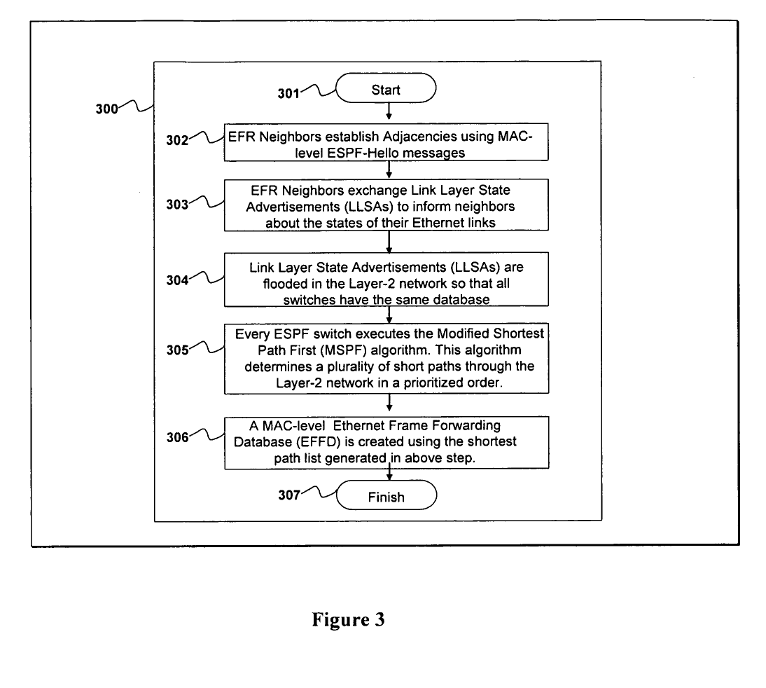

FIG. 3 is an operational flow diagram illustrating a process that is referred to as Ethernet Shortest Path First (ESPF). ESPF refers to an Ethernet MAC-level Route Protocol. The EFR switches are configured to perform a routing service at Ethernet MAC layer. Process 300 may be implemented in a system with different components than those contained in Layer-2 network 200 illustrated in FIG. 2.

Moving from a start block 301, the process goes to block 302 where the EFR neighbors establish adjacencies using MAC-level ESPF-Hello messages. “EFR neighbors” means the EFR switches configured to communicate with each other. The EFR neighbors are said to be adjacent to each other when the Layer-2 devices have optionally authenticated each other, and have agreed to form a relationship for the purpose of exchanging information including Link status and MAC reachability. Process 300 continues at block 303 where EFR neighbors then exchange Link Layer State Advertisement (LLSA) messages with each other. These Link Layer State Advertisement messages contain the states of their Ethernet links, and reachability of MAC addresses through those links. The process moves to block 304 where the LLSA messages are flooded through the Layer-2 network, so that all the participating EFR switches or bridges have the same database. Process 300 goes to block 305 where every EFR switch executes the Modified Shortest Path First (MSPF) algorithm. The Modified Shortest Path First algorithm makes determination about a plurality of short paths through the Layer-2 network in a prioritized order. The process continues at block 306 where a MAC level Ethernet Frame Forwarding Database (EFFD) is created using the plurality of paths determined at block 305. Then, process 300 ends at block 307.

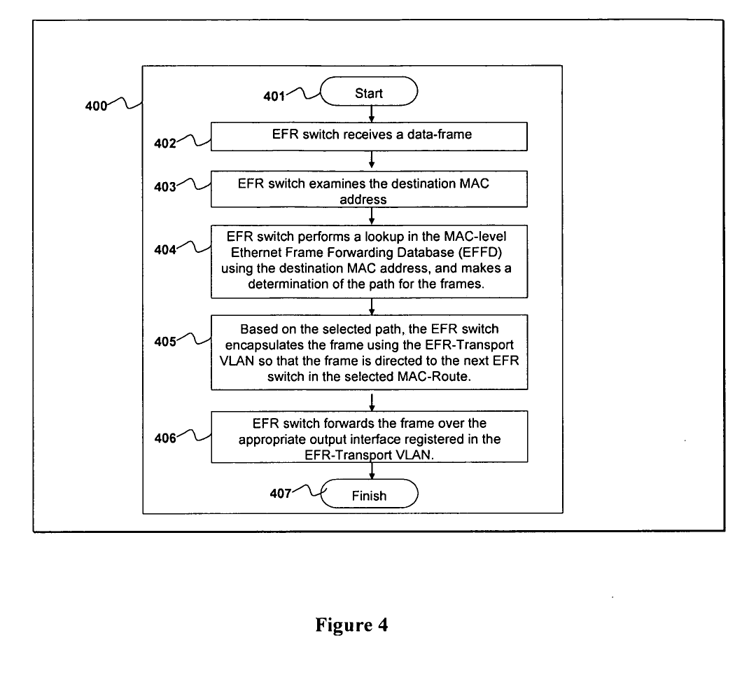

FIG. 4 is an operational flow diagram illustrating the data-plane forwarding process based on the EFR technology. Process 400 may be implemented in a system with different components than those contained in Layer-2 network 200 illustrated in FIG. 2. For the purposes of discussion, process 400 will be described in conjunction with FIG. 3 where an Ethernet Frame Forwarding Database (EFFD) was created at block 306.

Moving from a start block 401, the process goes to block 402 where an EFR switch receives an Ethernet frame. The process moves to block 403 where the EFR switch examines the destination MAC address. Process 400 goes to block 404 where the EFR switch performs a lookup in the MAC-level Ethernet Frame Forwarding Database (EFFD) using the destination MAC address. A determination is made about the Layer-2 path for forwarding the said frame. Moving to block 405, the EFR switch encapsulates the Ethernet frame using the EFR-Transport VLAN, so that the frame is directed to the next EFR switch in the selected MAC-Route. Process 400 then moves to block 406 where the EFR switch forwards the frame over the appropriate output interface registered in the EFR-Transport VLAN. After forwarding the packet, the process stops at block 407.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method for use in a communication system, comprising:
receiving frames; and
routing the frames in a network using Layer-2.

2. The method defined in claim 1, wherein the frames are Ethernet MAC frames.

3. The method defined in claim 1, wherein the frames are routed using Layer-2 MAC addresses.
